(19) United States
(12) Patent Application Publication
(10) Pub. No.: US 2018/0178650 A1
(43) Pub. Date: Jun. 28, 2018

(54) PROJECTION TYPE DISPLAY DEVICE AND PROJECTION CONTROL METHOD

(71) Applicant: FUJIFILM Corporation, Tokyo (JP)

(72) Inventor: Koudai FUJITA, Saitama (JP)

(73) Assignee: FUJIFILM Corporation, Tokyo (JP)

(21) Appl. No.: 15/905,750

(22) Filed: Feb. 26, 2018

Related U.S. Application Data
(63) Continuation of application No. PCT/JP2016/057562, filed on Mar. 10, 2016.

(30) Foreign Application Priority Data
Sep. 16, 2015 (JP) 2015-183262

(51) Int. Cl. B60K 35/00; E02F 9/26; G02B 27/01; G02B 26/08; A42B 3/04

(52) U.S. Cl. CPC B60K 35/00; E02F 9/26; G02B 27/0149; H04N 9/3111; A42B 3/04; G02B 2027/0159; G02B 26/0816

(57) ABSTRACT

Provided are a projection type display device and a projection control method capable of visually recognizing a virtual image in a wide range in front of a windshield of a working machine, without increasing the manufacturing cost of the working machine. A projection type display device that is mounted in a construction machine (100) having a windshield (7) detects a line of sight of an operator, controls a projection light axis of image light, emitted from a unit (2), into a direction that intersects a reflecting member (3) (or a reflecting member (5)) on the basis of the detected direction of the line of sight, controls an angle of a reflecting surface of the reflecting member (3) (or the reflecting member (5)) through a reflecting member driving mechanism (4) (or a reflecting member driving mechanism (6)), and reflects the image light, from the unit (2), onto the windshield (7).

### CROSS-REFERENCE TO RELATED APPLICATIONS

This application is a Continuation of PCT International Application No. PCT/JP2016/057562 filed on Mar. 10, 2016, which claims priority under 35 U.S.C § 119(a) to Japanese Patent Application No. 2015-183262 filed on Sep. 16, 2015. Each of the above application(s) is hereby expressly incorporated by reference, in its entirety, into the present application.

### BACKGROUND OF THE INVENTION

### 1. Field of the Invention

The present invention relates to a projection type display device and a projection control method.

### 2. Description of the Related Art

A vehicle head-up display (HUD) that projects, using a windshield of a vehicle such as an automobile or a combiner disposed in the vicinity of the windshield as a screen, light to the screen to display an image is known. According to the HUD, a user can set an image based on the light projected from the HUD as a real image on the screen, or can set the image as a virtual image in front of the screen, so that a driver can visually recognize the image.

JP2002-146846A and JP2010-18141A disclose a machine that is provided with an HUD, as a construction machine that belongs to a variety of machinery used for construction and civil engineering work, such as a shovel loader or a crane.

JP2009-243073A discloses a construction machine that is provided with a projector that projects image light onto a windshield.

### SUMMARY OF THE INVENTION

In a construction machine, movement of a line of sight of an operator is frequently performed, particularly, in a longitudinal direction, differently from a vehicle of which main purpose is transportation, such as an automobile. Further, a movement range of the line of sight of the operator in the longitudinal direction is wide differently from the vehicle of which main purpose is transportation. In addition, in the construction machine, the line of sight of the operator moves in accordance with movement of a power shovel and/or a bucket that is an operation target. Furthermore, in the construction machine, since an operation is performed while accurately operating the power shovel and/or the bucket, in a case where a windshield is present, it is preferable to sufficiently secure a visual field in front of the windshield. In consideration of these points, in a construction machine with a windshield in front of an operator's seat, it is preferable that a virtual image can be visually recognized over a wide range of the windshield.

The construction machine disclosed in JP2002-146846A is configured so that a virtual image can be visually recognized over a wide range by combining a semi-transparent spherical mirror having a sufficiently large size for covering a full visual field necessary for an operation of an operator and a projection unit that projects light onto the semi-transparent spherical mirror and has a variable projection direction. However, in such a construction machine, since it is difficult to perform optical design of the semi-transparent spherical mirror and a large semi-transparent spherical mirror is used, the manufacturing cost of the construction machine becomes high. Further, for example, there is a concern that the semi-transparent spherical mirror may be broken due to vibration during operation of the construction machine, or image blurring may occur, which leads to deterioration of workability and reliability.

The construction machine disclosed in JP2010-18141A has a configuration in which light is projected onto a windshield from operator's feet. Thus, in a case where a line of sight of an operator is directed upward, it is not possible for the operator to visually recognize a virtual image, and thus, it is not possible to present a virtual image over a wide range.

In the construction machine disclosed in JP2009-243073A, image light is projected onto a windshield using the projector to present a real image to an operator. Thus, a visual field at a portion where the image light is projected becomes poor, which may reduce working efficiency.

A configuration in which projection units are respectively provided on an upper side and a lower side from the position of the eyes of the operator and image light is projected onto an upper part and a lower part of a windshield so that a virtual image is visually recognized over a wide range may be considered. However, in this configuration, since the number of projection units becomes large, the manufacturing cost of a construction machine becomes high. Further, since there is restriction in a space of an operator's cab of the construction machine, it is difficult to secure a space for providing a plurality of projection units. In addition, in a case where the plurality of projection units is used, since a light source or the like is included in each projection unit, power consumption of the construction machine becomes large, or the temperature of the operator's cab becomes high due to heat radiation of the projection unit.

Hereinbefore, the problems have been described using a construction machine as an example, but the same problems may occur in an agricultural machine such as a tractor and other working machines. That is, the same problems occur in a working machine for performing work, such as a construction machine, an agricultural machine, and the like.

The invention has been made in consideration of the above-mentioned problems, and an object of the invention is to provide a projection type display device and a projection control method capable of visually recognizing a virtual image over a wide range in front of a windshield of a working machine, without increasing the manufacturing cost of the working machine and power consumption thereof.

According to an aspect of the invention, there is provided a projection type display device comprising: a unit that includes a projection unit that projects image light and a projection unit driving mechanism for changing a projection light axis of the image light from the projection unit, and is mounted at a head portion of an operator of a working machine; a sight line detection unit that detects a line of sight of the operator; a reflecting member that is provided in the working machine and includes a reflecting surface for reflecting the image light projected from the projection unit mounted at the head portion of the operator who sits on an operator's seat of the working machine onto a windshield of the working machine; a reflecting member driving mechanism for changing an angle of the reflecting surface with respect to the windshield; and a control unit that controls the projection light axis in the projection unit into a direction that intersects the reflecting surface of the reflecting member through the projection unit driving mechanism, and controls the angle of the reflecting surface of the reflecting member through the reflecting member driving mechanism, on the basis of the line of sight detected by the sight line detection unit.

According to another aspect of the invention, there is provided a projection control method of a projection type display device including a unit that includes a projection unit that projects image light and a projection unit driving mechanism for changing a projection light axis of the image light from the projection unit and is mounted at a head portion of an operator of a working machine, a reflecting member that is provided in the working machine and includes a reflecting surface for reflecting the image light projected from the projection unit mounted at the head portion of the operator who sits on an operator's seat of the working machine onto a windshield of the working machine, a reflecting member driving mechanism for changing an angle of the reflecting surface with respect to the windshield, comprising: a sight line detection step of detecting a line of sight of the operator; and a control step of controlling the projection light axis in the projection unit into a direction that intersects the reflecting surface of the reflecting member through the projection unit driving mechanism, and controlling the angle of the reflecting surface of the reflecting member through the reflecting member driving mechanism, on the basis of the line of sight detected in the sight line detection step.

According to the invention, it is possible to provide a projection type display device and a projection control method capable of visually recognizing a virtual image over a wide range in front of a windshield of a working machine, without increasing the manufacturing cost of the working machine.

### BRIEF DESCRIPTION OF THE DRAWINGS

FIG. 1 is a schematic diagram showing a schematic configuration of a construction machine 100 provided with an HUD system 10 that is an embodiment of a projection type display device of the invention.

FIG. 2 is a diagram showing an example of a configuration in an operator's cab in the construction machine 100 shown in FIG. 1.

FIG. 3 is a schematic diagram showing an internal configuration of a unit 2 that forms the HUD system 10 shown in FIG. 1.

FIG. 4 is a diagram illustrating a control example of a projection light axis of image light from the unit 2 and an angle of a reflecting surface of a reflecting member 5.

FIG. 5 is a diagram showing a control example of a projection light axis in a case where a line of sight of an operator is directed upward.

FIG. 6 is a diagram showing a control example of a projection light axis in a case where the line of sight of the operator is directed downward.

FIG. 7 is a diagram showing a projection light axis in a case where the line of sight of the operator is directed slightly upward.

FIG. 8 is a flowchart for illustrating an operation of the HUD system 10 shown in FIG. 1.

FIG. 9 is a schematic diagram showing an internal configuration of a unit 2a that is a modification example of the unit 2 shown in FIG. 3.

FIG. 10 is a flowchart for illustrating an operation of an HUD system 10 having the unit 2a shown in FIG. 9.

### DESCRIPTION OF THE PREFERRED EMBODIMENTS

Hereinafter, embodiments of the invention will be described with reference to the accompanying drawings.

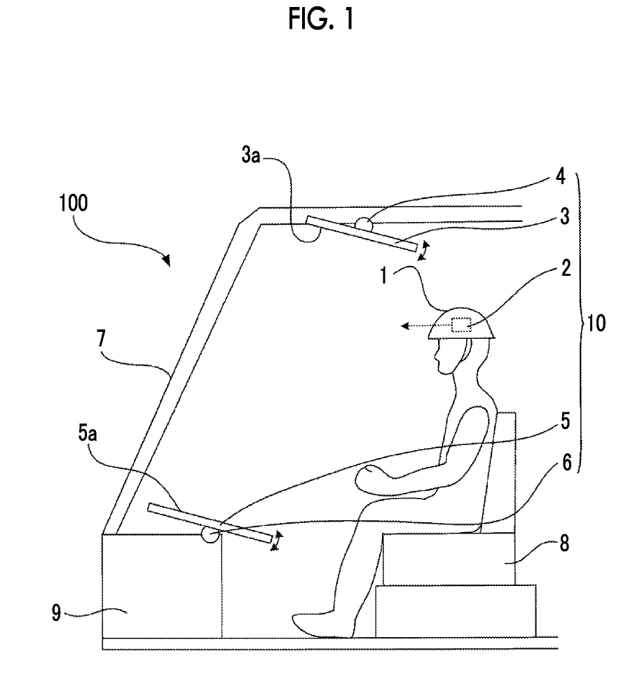

FIG. 1 is a schematic diagram showing a schematic configuration of a construction machine 100 provided with an HUD system 10 that is an embodiment of a projection type display device of the invention.

The HUD system 10 shown in FIG. 1 is mounted in the construction machine 100. And the HUD system 10 may be mounted in a working machine such as a farming machine, instead of the construction machine. That is, the HUD system 10 shown in FIG. 1 may be mounted in a construction machine and a working machine such as a farming machine.

The HUD system 10 shown in FIG. 1 includes a unit 2 that is fixedly provided in a helmet 1 that an operator wears on a head portion, a reflecting member 3 that is provided in an operator's cab above the head portion of the operator (a ceiling in an example of FIG. 1) in a state where the operator sits on an operator's seat 8 of the construction machine 100, a reflecting member driving mechanism 4 that rotationally moves and supports the reflecting member 3 on an upper side of the operator's cab, a reflecting member 5 that is provided in the operator's cab below the head portion of the operator (on a dashboard 9 in the example of FIG. 1), and a reflecting member driving mechanism 6 that rotationally moves and supports the reflecting member 5 on the dashboard 9. The unit 2 may be configured to be integrated with the helmet 1, or may be configured to be detachably attached to the helmet 1.

The helmet 1 is a cap-type protecting member that protects a person's head portion, and is worn by an operator who gets on the construction machine 100.

The unit 2 projects image light under the condition that a virtual image can be visually recognized in front of a windshield 7 of the construction machine 100. The unit 2 is fixed on a right side surface or a left side surface (in the example of FIG. 1, the right side surface) of the helmet 1, and is configured to be able to change a projection direction (projection light axis) of the image light according to the line of sight of the operator.

The reflecting member 3 includes a reflecting surface 3a for reflecting image light projected from the unit 2 that is fixedly provided in the helmet 1 onto the windshield 7. The reflecting member driving mechanism 4 rotates the reflecting member 3 to change an angle of the reflecting surface 3a with respect to the windshield 7. The reflecting surface 3a may be any surface coated with a material with high light reflectance, and for example, a mirror may be used as the reflecting member 3.

The reflecting member 5 includes a reflecting surface 5a for reflecting image light projected from the unit 2 that is fixedly provided in the helmet 1 onto the windshield 7. The reflecting member driving mechanism 6 rotates the reflecting member 5 to change an angle of the reflecting surface 5a with respect to the windshield 7. The reflecting surface 5a may be any surface coated with a material with high light reflectance, and for example, a mirror may be used as the reflecting member 5.

The reflecting member 3 and the reflecting member 5 are provided to be spaced from each other in a gravity direction (a longitudinal direction in FIG. 1) in the operator's cab of the construction machine 100, and thus, reflect image light emitted from the unit 2 that is fixedly provided in the helmet 1 at various angles.

The two reflecting members 3 and 5 form a reflecting member of the HUD system 10. Further, the two reflecting member driving mechanisms 4 and 6 form a reflecting member driving mechanism of the HUD system 10.

In the HUD system 10, the unit 2 is fixed in the helmet 1 that the operator wears, and is able to change a projection light axis of image light. Further, the reflecting member 3 and the reflecting member 5 are separated from each other in the gravity direction in the operator's cab of the construction machine 100, and are provided to be rotationally moved. With such a configuration, it is possible to present a virtual image to the operator over a wide range of the windshield 7.

The operator of the construction machine 100 can visually recognize information such as a picture, characters, or the like for assisting an operation of the construction machine 100 by viewing image light that is projected onto the windshield 7 and is reflected therefrom. Further, the windshield 7 has a function of reflecting image light projected from the unit 2 and simultaneously transmitting light from the outside (an outside world). Thus, the operator can visually recognize a virtual image based on image light projected from the unit 2 in a state where the virtual image is superimposed on a scene of the outside world.

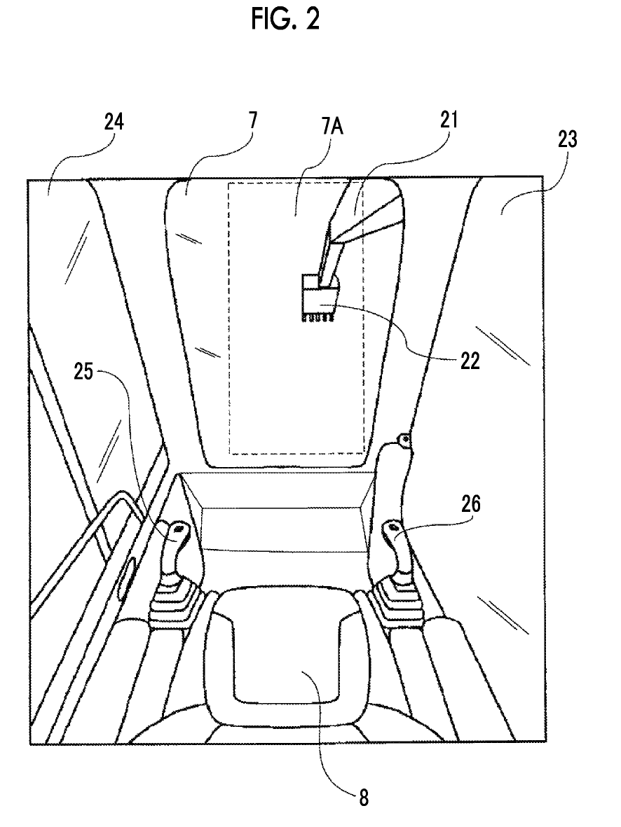

FIG. 2 is a diagram showing an example of a configuration in the operator's cab in the construction machine 100 shown in FIG. 1. FIG. 2 shows a front view in a state where the windshield 7 is seen from the operator's seat 8.

The construction machine 100 is a hydraulic shovel that includes an arm 21 and a bucket 22 in a front center of the machine.

The operator's cab is surrounded by transparent windows such as the windshield 7 that is a front window, a right window 23, a left window 24, and the like, and includes at least a left operating lever 25 for operating bending and stretching of the arm 21, a right operating lever 26 for operating digging and opening of the bucket 22, and the like around the operator's seat 8.

A projection range 7A is allocated on the windshield 7 as a region onto which image light projected from the unit 2 is projected, which reflects the image light and simultaneously transmits light from the outside (outside world).

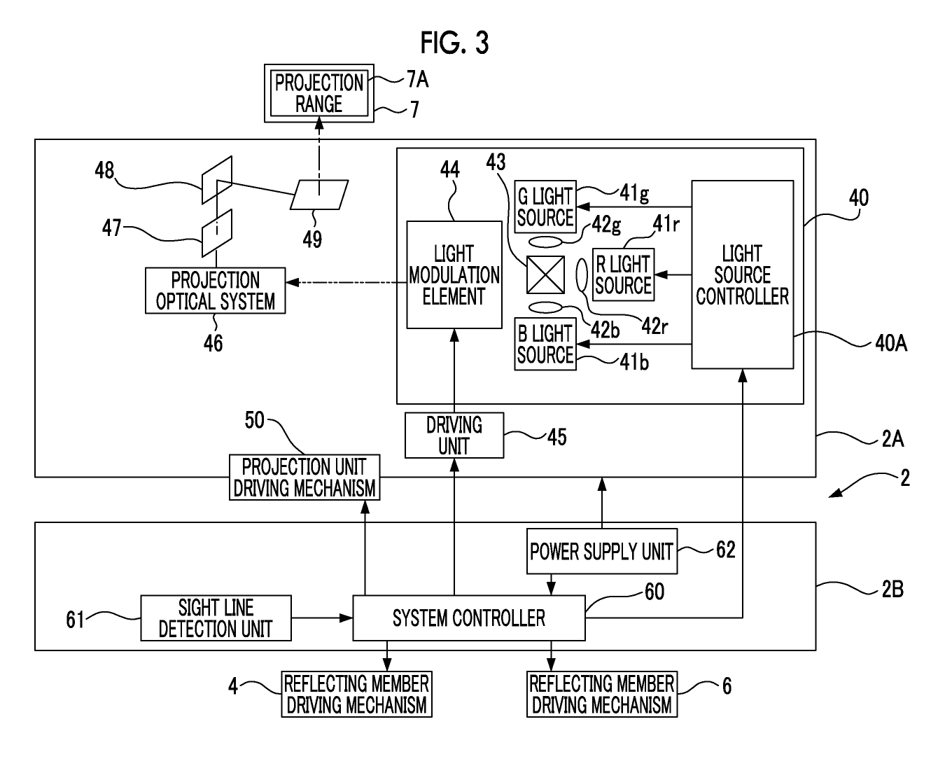

FIG. 3 is a schematic diagram showing an internal configuration of the unit 2 shown in FIG. 1.

The unit 2 includes a projection unit 2A that includes a light source unit 40, a driving unit 45, a projection optical system 46, a diffuser plate 47, a reflecting mirror 48, a magnifying glass 49, and a projection unit driving mechanism 50, a control unit 2B that includes a system controller 60, a sight line detection unit 61, and a power supply unit 62.

The projection unit 2A and the control unit 2B may be separately provided, or may be integrally provided.

The light source unit 40 includes a light source controller 40A, an R light source 41r that is a red light source that emits red light, a G light source 41g that is a green light source that emits green light, a B light source 41b that is a blue light source that emits blue light, a dichroic prism 43, a collimator lens 42r that is provided between the R light source 41r and the dichroic prism 43, a collimator lens 42g that is provided between the G light source 41g and the dichroic prism 43, a collimator lens 42b that is provided between the B light source 41b and the dichroic prism 43, and a light modulation element 44.

The dichroic prism 43 is an optical member for guiding light emitted from each of the R light source 41r, the G light source 41g, and the B light source 41b to the same optical path. That is, the dichroic prism 43 transmits red light that is collimated by the collimator lens 42r to be emitted to the light modulation element 44. Further, the dichroic prism 43 reflects green light that is collimated by the collimator lens 42g to be emitted to the light modulation element 44. Further, the dichroic prism 43 reflects blue light that is collimated by the collimator lens 42b to be emitted to the light modulation element 44. An optical member having such a function is not limited to a dichroic prism. For example, a cross dichroic mirror may be used.

The R light source 41r, the G light source 41g, and the B light source 41b respectively employ a light emitting element such as laser or a light emitting diode (LED). In this embodiment, an example in which the light sources of the light source unit 40 include three light sources of the R light source 41r, the G light source 41g, and the B light source 41b is shown, but the number of light sources may be 1, 2, 4 or more.

The light source controller 40A sets the amounts of luminescence of the R light source 41r, the G light source 41g, and the B light source 41b into predetermined luminescence amount patterns, and performs a control for sequentially emitting light from the R light source 41r, the G light source 41g, and the B light source 41b according to the luminescence amount patterns.

The light modulation element 44 modulates light emitted from the dichroic prism 43, and emits light (red color image light, blue color image light, and green color image light) based on projection image data that is image information to the projection optical system 46.

The light modulation element 44 may employ, for example, a liquid crystal on silicon (LCOS), a digital micromirror device (DMD), a micro electro mechanical systems (MEMS) element, a liquid crystal display device, or the like.

The driving unit 45 drives the light modulation element 44 according to projection image data input from the system controller 60, so that light (red color image light, blue color image light, and green color image light) based on the projection image data is emitted to the projection optical system 46.

The projection optical system 46 is an optical system for projecting visible light emitted from the light modulation element 44 of the light source unit 40 onto the diffuser plate 47. The optical system is not limited to a lens, and may employ a scanner. For example, the diffuser plate 47 may diffuse light emitted from a scanning-type scanner to become a plane light source.

The reflecting mirror 48 reflects light diffused by the diffuser plate 47 toward the magnifying glass 49.

The magnifying glass 49 magnifies an image based on light reflected by the reflecting mirror 48 to be projected onto the windshield 7.

The light source unit 40, the projection optical system 46, the diffuser plate 47, and the reflecting mirror 48, and the magnifying glass 49 in the projection unit 2A form a projection unit of the HUD system 10 that projects image light based on projection image data.

The projection unit driving mechanism 50 is a driving mechanism for changing a projection light axis of image light projected from the projection unit 2A, and changes the projection light axis by rotating the projection unit 2A. The projection unit driving mechanism 50 is controlled by the system controller 60. As the projection unit 2A is rotated, the projection light axis of the image light emitted from the projection unit 2A is changed.

The system controller 60 controls the light source controller 40A, the driving unit 45, and the projection unit driving mechanism 50. The system controller 60 controls the driving unit 45 and the light source controller 40A, so that image light based on projection image data is projected.

The system controller 60 controls the projection unit driving mechanism 50 to rotate the projection unit 2A, and controls the projection light axis of the image light emitted from the projection unit 2A.

The system controller 60 is able to communicate with the reflecting member driving mechanism 4 and the reflecting member driving mechanism 6, and controls an angle of the reflecting surface 3a of the reflecting member 3 with respect to the windshield 7 through the reflecting member driving mechanism 4 and controls an angle of the reflecting surface 5a of the reflecting member 5 with respect to the windshield 7 through the reflecting member driving mechanism 6.

The system controller 60 forms a control unit of the HUD system 10. A detailed function of the system controller 60 will be described later.

The sight line detection unit 61 detects a line of sight of an operator, and inputs information indicating the detected line of sight of the operator to the system controller 60.

As a method for detecting the line of sight of the operator, for example, a first detection method and a second detection method to be described below may be used, but the invention is not limited to these methods.

(First Detection Method)

For example, an imaging unit is mounted in the dashboard 9 of the construction machine 100, and the imaging unit captures the face of the operator who sits on the operator's seat 8 and transmits captured image data to the sight line detection unit 61 through wireless communication. Further, the sight line detection unit 61 analyzes the captured image data through a known image analysis process to detect the direction of the line of sight of the operator.

(Second Detection Method)

For example, an acceleration sensor is mounted in the control unit 2B of the unit 2. Since the control unit 2B is fixedly provided in the helmet 1, acceleration information output from the acceleration sensor becomes information depending on movement of the head portion of the operator. By determining how much the head portion is tilted on the basis of the acceleration information, it is possible to detect the direction of the line of sight of the operator with approximate accuracy.

The power supply unit 62 is a power source device that supplies power to the system controller 60 and the sight line detection unit 61 and supplies power to the entirety of the projection unit 2A. The power supply unit 62 may be an exchangeable battery type, or may be a chargeable battery type. Since the unit 2 is operated by a battery from the power supply unit 62, the unit 2 is not supplied with power from the construction machine 100, and thus, fuel efficiency of the construction machine 100 can be enhanced. Further, a configuration in which power supply to the unit 2 is performed through wireless power supply may be used.

The system controller 60 reads out, on the basis of the line of sight of the operator detected by the sight line detection unit 61, adjustment data corresponding to the line of sight of the operator with reference to a table stored in an internal memory (not shown) in advance, and controls the reflecting member driving mechanism 4, the reflecting member driving mechanism 6, and the projection unit driving mechanism 50 on the basis of the read-out adjustment data.

In the table stored in the internal memory, directions of lines of sight, rotation angles of the projection unit 2A, rotation angles of the reflecting member 3 or the reflecting member 5 are stored in association as adjustment data.

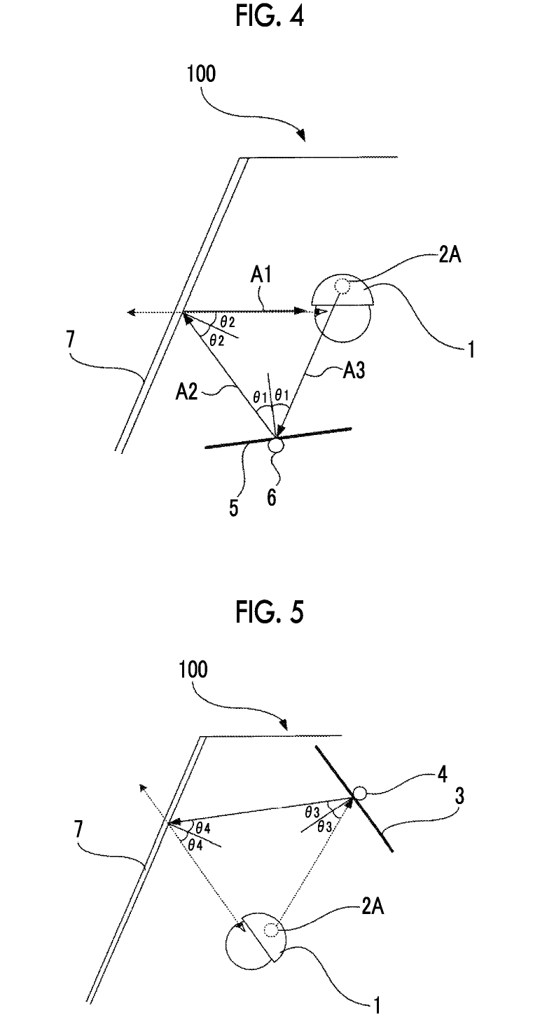

For example, as shown in FIG. 4, in a situation where the line of sight of the operator is directed frontward, in order to cause the operator to visually recognize a virtual image, it is necessary to input image light emitted from the projection unit 2A to the eyes of the operator in a sight line direction A1. However, since the projection unit 2A is mounted at the head portion of the operator, the projection unit 2A is located at a position that deviates from the line of sight of the operator, and it is not necessary that the windshield 7 is vertically provided. Thus, even if image light is directly projected onto the windshield 7 from the projection unit 2A, it is difficult to input the image light to the eyes of the operator in the sight line direction A1.

Here, when an angle formed by the sight line direction A1 and a normal direction of the windshield 7 at an intersection position of the sight line direction A1 and the windshield 7 is represented as an angle θ2 and an angle formed by a direction A2 of reflected light in a case where light that travels in the sight line direction A1 from the eyes of the operator is regularly reflected at the intersection position on the windshield 7 and a normal direction of the reflecting surface 5a is represented as an angle θ1, by projecting image light in a direction A3 that forms the angle θ1 with respect to the normal line of the reflecting surface 5a of the reflecting member 5 from the projection unit 2A, it is possible to input the image light to the eyes of the operator in the sight line direction A1.

Accordingly, in this case, with respect to the sight line direction of the operator, information on a combination of the amount of rotation of the projection unit 2A and the amount of rotation of the reflecting surface 5a for realizing incidence of image light onto the reflecting surface 5a at the angle θ1 is generated as adjustment data in association.

In this way, the amount of rotation of the reflecting surface of the reflecting member 5 (or the reflecting member 3) and the amount of rotation of the projection unit 2A are calculated for each sight line direction of the operator so that the image light enters the eyes of the operator in the sight line directions of the operator, and are stored in advance in an internal memory as adjustment data.

Here, the adjustment data is generated in advance and is stored in the internal memory, but the adjustment data may be calculated for use in real time using design information of the construction machine 100, structure and arrangement information of the reflecting member 3 and the reflecting member 5.

FIG. 5 is a diagram showing a control example of a projection light axis of image light in a case where the line of sight of the operator is directed upward.

In a case where it is detected by the sight line detection unit 61 that the line of sight of the operator is directed upward, the system controller 60 reads out adjustment data associated with the sight line direction detected by the sight line detection unit 61 from the internal memory.

The system controller 60 controls the projection unit driving mechanism 50 and the reflecting member driving mechanism 4 on the basis of the read-out adjustment data. The projection unit driving mechanism 50 and the reflecting member driving mechanism 4 controls the amount of rotations of the projection unit 2A and the reflecting member 3 so that an angle formed by a projection light axis of image light emitted from the projection unit 2A and a normal direction of the reflecting surface 3a of the reflecting member 3 becomes 03.

Through this control, the image light emitted from the projection unit 2A enters the reflecting member 3 at an incidence angle θ3, and is reflected at a reflecting angle θ3. Then, the image light enters the projection surface of the windshield 7 at an incidence angle θ4, and is reflected at a reflecting angle θ4, and then, enters the eyes of the operator. Thus, even in a case where the line of sight of the operator is directed upward, it is possible for the operator to reliably visually recognize a virtual image based on the image light projected onto the windshield 7.

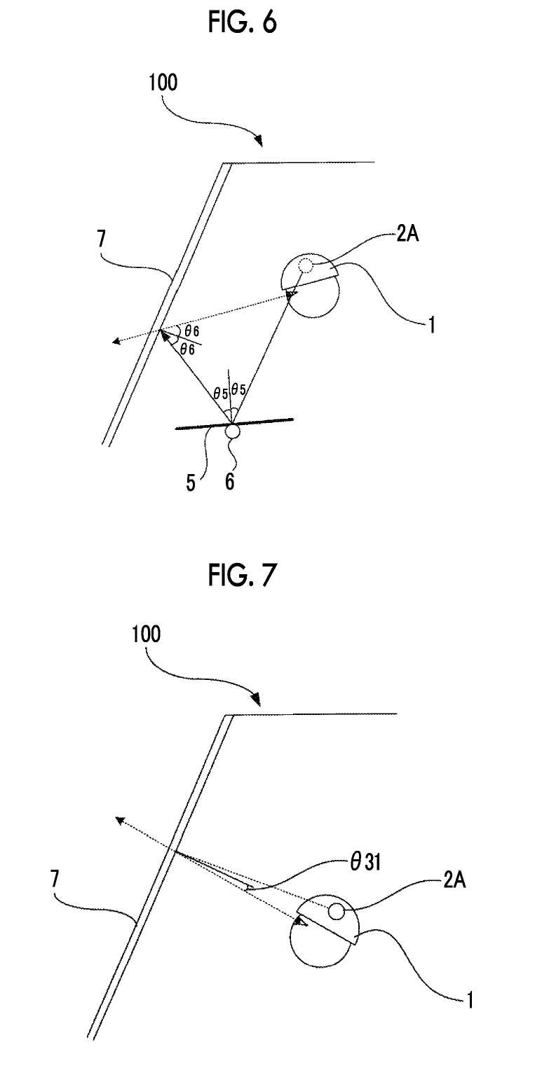

FIG. 6 is a diagram showing a control example of a projection light axis of image light in a case where the line of sight of the operator is directed downward.

In a case where it is detected by the sight line detection unit 61 that the line of sight of the operator is directed downward, the system controller 60 reads out adjustment data associated with the sight line direction detected by the sight line detection unit 61 from the internal memory.

The system controller 60 controls the projection unit driving mechanism 50 and the reflecting member driving mechanism 6 on the basis of the read-out adjustment data. The projection unit driving mechanism 50 and the reflecting member driving mechanism 6 control the amount of rotations of the projection unit 2A and the reflecting member 5 so that an angle formed by a projection light axis of image light emitted from the projection unit 2A and the normal direction of the reflecting surface 5a of the reflecting member 5 becomes θ5.

Through this control, the image light emitted from the projection unit 2A enters the reflecting member 5 at an incidence angle θ5, and is reflected at a reflecting angle θ5. Then, the image light enters the projection surface of the windshield 7 at an incidence angle θ6, and is reflected at a reflecting angle θ6, and then, enters the eyes of the operator. Thus, even in a case where the line of sight of the operator is directed downward, it is possible for the operator to reliably visually recognize a virtual image based on the image light projected onto the windshield 7.

Hereinbefore, a configuration in which the sight line direction, the amount of rotation of the projection unit 2A, the amount of rotation of the reflecting member 3 or the reflecting member 5 are associated with each other as the adjustment data has been described. However, as shown in FIG. 7, in a case where an angle θ31 formed by the normal direction of the windshield 7 and the sight line direction of the operator is equal to or smaller than a threshold value, it is not possible to cause image light to enter the eyes of the operator in the sight line direction using a method of reflecting the image light from the reflecting surface 5a or the reflecting surface 3a. In such a case, it is necessary to directly project image light onto the windshield 7.

Thus, only in such a case, data in which the normal direction and the amount of rotation of the projection unit 2A is associated with each other is stored in the internal memory as the adjustment data.

Specifically, in the case shown in FIG. 7, with respect to the sight line direction of the operator, the amount of rotation of the projection unit 2A for realizing incidence of image light onto the windshield 7 at the angle θ31 is stored as adjustment data in association.

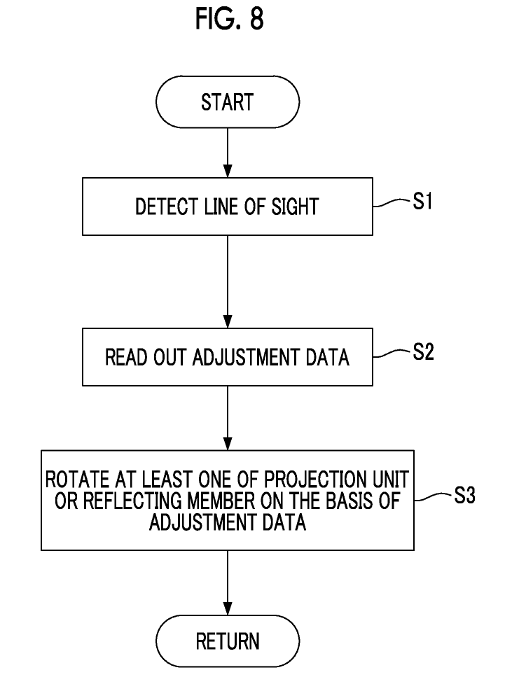

FIG. 8 is a flowchart for illustrating an operation of the HUD system 10 shown in FIG. 1.

When the HUD system 10 is started, the sight line detection unit 61 of the control unit 2B detects a line of sight of the operator (step S1).

The system controller 60 reads out adjustment data corresponding to information on the sight line direction input from the sight line detection unit 61 from the internal memory (step S2).

The system controller 60 controls at least one of the projection unit driving mechanism 50, or the reflecting member driving mechanism 4 or the reflecting member driving mechanism 6 on the basis of the read-out adjustment data, and rotates at least one of the projection unit 2A or the reflecting member 3 (or the reflecting member 5) (step S3).

Through step S3, image light based on projection image data emitted from the projection unit 2A is projected onto a projection range 7A of the windshield 7. The projection image data corresponds to data for representing traveling speed information, fuel information, construction information, or the like of the construction machine 100, for example.

After step S3, the procedure returns to step S1, and the above-described processes are repeated.

As described above, according to the HUD system 10 shown in FIG. 1, during operation at the working site, it is possible to project image light onto a wide range of the windshield 7 using the unit 2 that is fixedly provided in the helmet 1 that the operator wears, the reflecting member 3 and the reflecting member 5 that are provided to be spaced from each other in the gravity direction. Thus, even in a case where movement of a line of sight of an operator in a longitudinal direction becomes large according to movement of a shovel, a bucket, or the like that is an operation target, it is possible to perform sufficient working assistance to the operator.

Further, the HUD system 10 has a configuration in which one projection unit 2A is provided. Thus, compared with a configuration in which a plurality of projection units is mounted in the construction machine 100, it is possible to reduce the manufacturing cost of the HUD system 10. In addition, since the projection unit 2A is fixed in the helmet 1, it is possible to present a virtual image over a wide range without restriction in space in the operator's cab of the construction machine 100, which does not influence design of the construction machine 100.

Further, according to the HUD system 10, since one projection unit 2A is provided, it is possible to reduce power consumption and heat generation of the HUD system 10. In addition, according to the HUD system 10, since the unit 2 is operated using a battery, it is possible to enhance fuel efficiency of the construction machine 100 without consuming power of the construction machine 100 for the HUD system 10.

Furthermore, according to the HUD system 10, it is possible to present a virtual image over a wide range using the unit 2, and the reflecting member 3 and the reflecting member 5 having simple structures. Thus, compared with a case where a semi-transparent spherical mirror having a complicated structure is used, it is possible to reduce the manufacturing cost of the device, and to enhance reliability of the device.

In the above description, the unit 2 having the projection unit 2A and the control unit 2B is fixedly provided in the helmet 1, but the control unit 2B may be provided outside the unit 2, for example, inside the dashboard 9 of the construction machine 100.

In this case, a configuration in which the power supply unit 62 is provided in the projection unit 2A and the system controller 60 of the control unit 2B controls respective units of the projection unit 2A that is fixedly provided in the helmet 1 through wireless communication is obtained. The control unit 2B outside the unit 2 may be operated by a battery, or may be supplied with power from a power supply unit (not shown) of the construction machine 100.

In this way, with such a configuration in which the control unit 2B is outside the unit 2, it is possible to achieve reduction in weight of the unit 2 mounted in the helmet 1, and to reduce burden of an operator who wears the helmet 1.

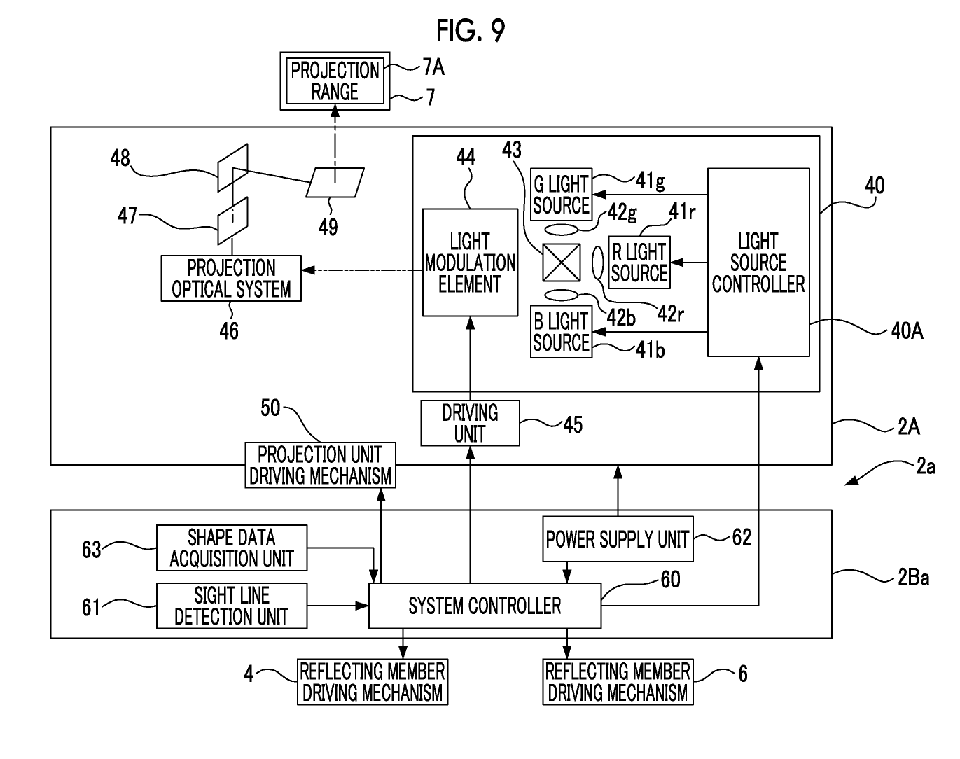

FIG. 9 is a schematic diagram showing an internal configuration of a unit 2a that is a modification example of the unit 2 shown in FIG. 3. In FIG. 9, the same components as in FIG. 3 are given the same reference numerals, and description thereof will not be repeated.

The unit 2a shown in FIG. 9 has a configuration in which the control unit 2B is modified to a control unit 2Ba in the unit 2.

The control unit 2Ba has a configuration in which a shape data acquisition unit 63 is added to the configuration of the control unit 2B.

The shape data acquisition unit 63 acquires shape data of the windshield 7, and inputs the acquired shape data to the system controller 60.

As a method for acquiring the shape data of the windshield 7, a method for acquiring shape data from a measurement device that measures a three-dimensional shape of an object provided in the construction machine 100 may be used. The measurement device employs a depth sensor, for example.

The depth sensor may employ known types of sensors such as a sensor type for calculating a distance to an object by a time-of-flight method or the like using an infrared light emitting part and an infrared light receiving part, a sensor type for calculating a distance to an object on the basis of data on two captured images obtained by imaging the object using two cameras, or a sensor type for calculating a distance to an object on the basis of data on a plurality of captured images obtained by imaging the object at a plurality of positions while moving one camera.

Further, the method for acquiring the shape data of the windshield 7 may employ a method for storing shape data of the windshield 7 that is measured in advance using the measurement device and storing the result in a memory, and acquiring the shape data from the memory.

The system controller 60 determines, on the basis of a line of sight of an operator detected by the sight line detection unit 61 and shape data acquired by the shape data acquisition unit 63, an intersection position of the line of sight on the windshield 7. Further, the system controller 60 calculates an angle (02 in the example of FIG. 4) formed by a perpendicular direction of the windshield 7 and the sight line direction of the operator detected by the sight line detection unit 61 at the intersection position.

In the example shown in FIG. 4, in a case where the angle θ2 can be calculated, it is possible to determine the amount of rotation of the reflecting member 5 and the amount of rotation of the projection unit 2A necessary for incidence of image light onto the intersection position of the windshield 7 at the incidence angle θ2. In the control unit 2B shown in FIG. 9, adjustment data on which the above angle, the amount of rotation of the reflecting member 3 or the reflecting member 5, and the amount of rotation of the projection unit 2A are associated with each other is stored in the internal memory.

In the example shown in FIG. 7, the angle θ31 becomes small. In this case, the amount of rotation of the projection unit 2A necessary for incidence of image light at the incidence angle θ31 onto the intersection position of the windshield 7 and the angle θ31 are stored as adjustment data in the internal memory in association.

The system controller 60 acquires adjustment data corresponding to the calculated angle, and controls the reflecting member driving mechanism 4, the reflecting member driving mechanism 6, and the projection unit driving mechanism 50 on the basis of the adjustment data.

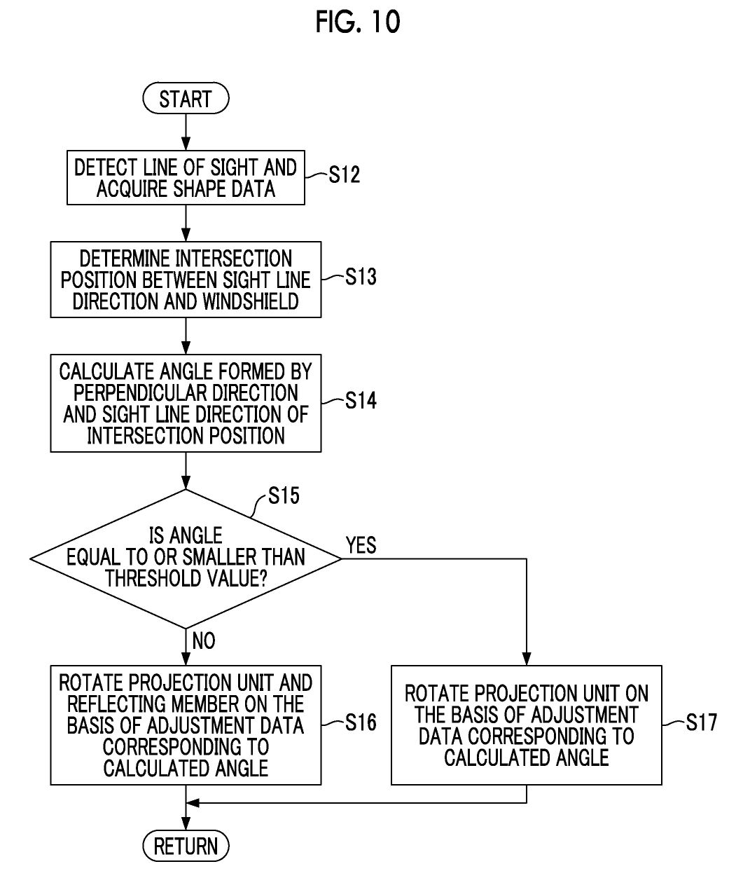

FIG. 10 is a flowchart for illustrating an operation of the HUD system 10 having the unit 2a shown in FIG. 9.

When the HUD system 10 is started, the sight line detection unit 61 of the control unit 2Ba detects a line of sight of an operator, and the shape data acquisition unit 63 acquires shape data of the windshield 7 (step S12).

The system controller 60 determines an intersection position of a line of sight of the operator and the windshield 7 on the basis of information on the sight line direction input from the sight line detection unit 61 and the shape data acquired by the shape data acquisition unit 63 (step S13).

Then, the system controller 60 calculates an angle formed by a perpendicular direction of the windshield 7 at the intersection position determined in step S13 and the sight line direction input from the sight line detection unit 61 (step S14).

The system controller 60 determines whether the calculated angle is equal to or smaller than a threshold value (step S15). In a case where it is determined that the angle exceeds the threshold value (NO in step S15), the system controller 60 rotates the projection unit 2A, the reflecting member 3 or the reflecting member 5 on the basis of adjustment data corresponding to the angle (step S16).

Through the process of step S16, the direction of a projection light axis in the projection unit 2A is controlled into a direction that intersects the reflecting surface of the reflecting member 3 or the reflecting member 5, and thus, an angle of the reflecting surface of the reflecting member 3 or the reflecting member 5 with respect to the windshield 7 is controlled. Accordingly, image light based on projection image data emitted from the projection unit 2A is reflected from the reflecting member 3 or the reflecting member 5, and is projected onto the intersection position on the windshield 7. Then, the image light is reflected at the intersection position again, and enters the eyes of the operator.

On the other hand, in a case where it is determined that the angle calculated in step S14 is equal to or smaller than the threshold value (YES in step S15), the system controller 60 rotates the projection unit 2A on the basis of adjustment data corresponding to the angle (step S17).

Through the process of step S17, the direction of the projection light axis in the projection unit 2A is controlled into a direction that intersects the windshield 7, and the angle of the reflecting surface of the reflecting member 3 or the reflecting member 5 with respect to the windshield 7 is not controlled. Accordingly, the image light based on the projection image data emitted from the projection unit 2A is directly projected onto the intersection position of the windshield 7, and is reflected at the intersection position, and then, enters the eyes of the operator.

After the process of step S16 or step S17, the procedure returns to step S12 and the above-described processes are repeated.

As described above, according to the unit 2a shown in FIG. 9, the intersection position of the line of sight and the windshield 7 is determined on the basis of the shape data of the windshield 7 and the line of sight of the operator, and the projection unit 2A, the reflecting member 3 or the reflecting member 5 are rotated with driving amounts corresponding to the angle formed by the perpendicular direction calculated from the determined intersection position and the sight line direction.

The shape of the windshield 7 varies according to types of the construction machine 100, or varies according to manufacturing errors even in a case where the types are the same. Accordingly, by determining the driving amounts (the amount of rotations) of the projection unit 2A and the reflecting member 3 or the reflecting member 5 using the shape data of the windshield 7 measured by the measurement device, it is possible to accurately the rotation control of the projection unit 2A and the reflecting member 3 or the reflecting member 5.

As described above, the following configurations are disclosed in this specification.

A disclosed projection type display device includes: a unit that includes a projection unit that projects image light and a projection unit driving mechanism for changing a projection light axis of the image light from the projection unit, and is mounted at a head portion of an operator of a working machine; a sight line detection unit that detects a line of sight of the operator; a reflecting member that is provided in the working machine and includes a reflecting surface for reflecting the image light projected from the projection unit mounted at the head portion of the operator who sits on an operator's seat of the working machine onto a windshield of the working machine; a reflecting member driving mechanism for changing an angle of the reflecting surface with respect to the windshield; and a control unit that controls the projection light axis in the projection unit into a direction that intersects the reflecting surface of the reflecting member through the projection unit driving mechanism, and controls the angle of the reflecting surface of the reflecting member through the reflecting member driving mechanism, on the basis of the line of sight detected by the sight line detection unit.

The disclosed projection type display device further includes a shape data acquisition unit that acquires shape data of the windshield, and the control unit determines an intersection position of the line of sight on the windshield on the basis of the line of sight detected by the sight line detection unit and the shape data acquired by the shape data acquisition unit, and drives the projection unit and the reflecting member with driving amounts corresponding to an angle formed by a normal direction of the windshield and a direction of the line of sight at the determined intersection position.

The disclosed projection type display device is configured so that the control unit controls, in a case where the angle is equal to or smaller than a threshold value, the projection light axis in the projection unit into a direction that intersects the windshield through the projection unit driving mechanism, and directly projects the image light from the projection unit onto the windshield.

The disclosed projection type display device is configured so that the unit is fixedly used in a cap-type protecting member that protects a human's head portion.

The disclosed projection type display device is configured so that the control unit is provided inside the unit.

The disclosed projection type display device is configured so that the unit is operated by a battery provided in the unit.

The disclosed projection type display device is configured so that the reflecting member is formed by two reflecting members that are disposed to be spaced from each other in a gravity direction.

A disclosed projection control method is a projection control method of a projection type display device including a unit that includes a projection unit that projects image light and a projection unit driving mechanism for changing a projection light axis of the image light from the projection unit and is mounted at a head portion of an operator of a working machine, a reflecting member that is provided in the working machine and includes a reflecting surface for reflecting the image light projected from the projection unit mounted at the head portion of the operator who sits on an operator's seat of the working machine onto a windshield of the working machine, a reflecting member driving mechanism for changing an angle of the reflecting surface with respect to the windshield, and includes: a sight line detection step of detecting a line of sight of the operator; and a control step of controlling the projection light axis in the projection unit into a direction that intersects the reflecting surface of the reflecting member through the projection unit driving mechanism, and controlling the angle of the reflecting surface of the reflecting member through the reflecting member driving mechanism, on the basis of the line of sight detected in the sight line detection step.

The disclosed projection control method further includes a shape data acquisition step of acquiring shape data of the windshield, and in the control step, an intersection position of the line of sight on the windshield is determined on the basis of the line of sight detected in the sight line detection step and the shape data acquired in the shape data acquisition step, and the projection unit and the reflecting member are driven with driving amounts corresponding to an angle formed by a normal direction of the windshield and a direction of the line of sight at the determined intersection position.

The disclosed projection control method is configured so that in the control step, in a case where the angle is equal to or smaller than a threshold value, the projection light axis in the projection unit is controlled into a direction that intersects the windshield through the projection unit driving mechanism, and the image light is directly projected from the projection unit onto the windshield.

The disclosed projection control method is configured so that the unit is fixedly used in a cap-type protecting member that protects a human's head portion.

The disclosed projection control method is configured so that the unit is operated by a battery.

The disclosed projection control method is configured so that the reflecting member is formed by two reflecting members that are disposed to be spaced from each other in a gravity direction.

The invention is applied to a construction machine and a working machine such as an agricultural machine, which provides high comfort and effectiveness.

### EXPLANATION OF REFERENCES

2: unit
2A: projection unit
2B: control unit
3: reflecting member
4: reflecting member driving mechanism
5: reflecting member
6: reflecting member driving mechanism
7: windshield
10: HUD system
40: light source unit
45: driving unit
60: system controller
61: sight line detection unit
62: power supply unit
63: shape data acquisition unit
100: construction machine

What is claimed is:

1. A projection type display device comprising:
a unit that includes a projection unit that projects image light and a projection unit driving mechanism for changing a projection light axis of the image light from the projection unit, and is mounted at a head portion of an operator of a working machine;
a sight line detection unit that detects a line of sight of the operator;
a reflecting member that is provided in the working machine and includes a reflecting surface for reflecting the image light projected from the projection unit mounted at the head portion of the operator who sits on an operator's seat of the working machine onto a windshield of the working machine;
a reflecting member driving mechanism for changing an angle of the reflecting surface with respect to the windshield; and
a control unit that controls the projection light axis in the projection unit into a direction that intersects the reflecting surface of the reflecting member through the projection unit driving mechanism, and controls the angle of the reflecting surface of the reflecting member through the reflecting member driving mechanism, on the basis of the line of sight detected by the sight line detection unit.

2. The projection type display device according to claim 1, further comprising:
a shape data acquisition unit that acquires shape data of the windshield,
wherein the control unit determines an intersection position of the line of sight on the windshield on the basis of the line of sight detected by the sight line detection unit and the shape data acquired by the shape data acquisition unit, and drives the projection unit and the reflecting member with driving amounts corresponding to an angle formed by a normal direction of the windshield and a direction of the line of sight at the determined intersection position.

3. The projection type display device according to claim 2,
wherein the control unit controls, in a case where the angle is equal to or smaller than a threshold value, the projection light axis in the projection unit into a direction that intersects the windshield through the projection unit driving mechanism, and directly projects the image light from the projection unit onto the windshield.

4. The projection type display device according to claim 1,
wherein the unit is fixedly used in a cap-type protecting member that protects a human's head portion.

5. The projection type display device according to claim 2,
wherein the unit is fixedly used in a cap-type protecting member that protects a human's head portion.

6. The projection type display device according to claim 3,
wherein the unit is fixedly used in a cap-type protecting member that protects a human's head portion.

7. The projection type display device according to claim 4,
wherein the control unit is provided inside the unit.

8. The projection type display device according to claim 5,
wherein the control unit is provided inside the unit.

9. The projection type display device according to claim 6,
wherein the control unit is provided inside the unit.

10. The projection type display device according to claim 4,
wherein the unit is operated by a battery provided in the unit.

11. The projection type display device according to claim 1,
wherein the reflecting member is formed by two reflecting members that are disposed to be spaced from each other in a gravity direction.

12. A projection control method of the projection type display device according to claim 1 including the unit that includes the projection unit that projects image light and the projection unit driving mechanism for changing the projection light axis of the image light from the projection unit and is mounted at a head portion of an operator of a working machine, the reflecting member that is provided in the working machine and includes the reflecting surface for reflecting the image light projected from the projection unit mounted at the head portion of the operator who sits on an operator's seat of the working machine onto the windshield of the working machine, the reflecting member driving mechanism for changing an angle of the reflecting surface with respect to the windshield, comprising:
a sight line detection step of detecting a line of sight of the operator; and
a control step of controlling the projection light axis in the projection unit into a direction that intersects the reflecting surface of the reflecting member through the projection unit driving mechanism, and controlling the angle of the reflecting surface of the reflecting member through the reflecting member driving mechanism, on the basis of the line of sight detected in the sight line detection step.

13. The projection control method according to claim 12, further comprising:
a shape data acquisition step of acquiring shape data of the windshield,
wherein in the control step, an intersection position of the line of sight on the windshield is determined on the basis of the line of sight detected in the sight line detection step and the shape data acquired in the shape data acquisition step, and the projection unit and the reflecting member are driven with driving amounts corresponding to an angle formed by a normal direction of the windshield and a direction of the line of sight at the determined intersection position.

14. The projection control method according to claim 13,
wherein in the control step, in a case where the angle is equal to or smaller than a threshold value, the projection light axis in the projection unit is controlled into a direction that intersects the windshield through the projection unit driving mechanism, and the image light is directly projected from the projection unit onto the windshield.

15. The projection control method according to claim 12,
wherein the unit is fixedly used in a cap-type protecting member that protects a human's head portion.

16. The projection control method according to claim 13,
wherein the unit is fixedly used in a cap-type protecting member that protects a human's head portion.

17. The projection control method according to claim 14,
wherein the unit is fixedly used in a cap-type protecting member that protects a human's head portion.

18. The projection control method according to claim 15,
wherein the unit is operated by a battery.

19. The projection control method according to claim 16,
wherein the unit is operated by a battery.

20. The projection control method according to claim 12,
wherein the reflecting member is formed by two reflecting members that are disposed to be spaced from each other in a gravity direction.
